(19) United States
(12) Patent Application Publication
(10) Pub. No.: US 2013/0204826 A1
(43) Pub. Date: Aug. 8, 2013

(54) SYSTEM AND METHOD FOR IDENTIFICATION OF SIMILAR EVENTS USING DATA AND CHARACTERISTICS

(71) Applicant: AvMet Applications Inc., Reston, VA (US)

(72) Inventors: Robert S. LEE, Reston, VA (US); Sadegh KAVOUSSI, Reston, VA (US); Mark PHANEUF, Reston, VA (US); David HICKMAN, Reston, VA (US); Michael ROBINSON, Reston, VA (US); Chad CRAUN, Reston, VA (US); Mate KLEIN, Reston, VA (US); Mark DEANS, Reston, VA (US); Alexander KLEIN, Reston, VA (US)

(73) Assignee: AVMET APPLICATIONS INC., Reston, VA (US)

(21) Appl. No.: 13/761,511

(22) Filed: Feb. 7, 2013

Related U.S. Application Data
(60) Provisional application No. 61/595,785, filed on Feb. 7, 2012.

(51) Int. Cl. G06N 5/02

(52) U.S. Cl. CPC G06N 5/02
USPC 706/46

(57) ABSTRACT

A similar event algorithm is used to compare a user specified event to a large historical binary gridded database of historical data, and identify similar events within the database. The user specified event input data is converted into a binary data format. The historical binary gridded database also is in a binary data format, such that the data is machine-readable. A similar event dataset is generated with similar events ranked according to the algorithm.

### FIELD OF THE INVENTION

The invention relates generally to the objective identification of events that are similar to a set of data and the associated characteristics using a similar event algorithm. More particularly, the present invention relates to a system and related methods to identify similar events using unique characteristics and a proprietary algorithm analysis of large amounts of data accomplished in an expeditious length of time.

### DISCUSSION OF THE RELATED ART

Analyzing historical data based events with the goal of identifying events which are similar to that which is desired is not a trivial task. Oftentimes the datasets required to complete a task are large and the similarity of various events is typically a subjective analysis which is time consuming and leads to inaccuracies. Attempting to find a similar gridded dataset or event within a dataset through the analysis of large historical datasets (i.e., years, hundreds of files, etc.) in order to identify those parameters, characteristics, and patterns which are similar is also a time consuming and difficult task. Database queries and searches are unable to identify patterns on grids, evaluate evolutions of gridded data values, and evaluate those findings against a separate dataset.

### SUMMARY OF THE INVENTION

The disclosed embodiments describe an objective process which is able to have users input a desired event and quickly search through large dataset(s) for a resultant objective analysis containing a list of the most similar events to that which is desired.

The objective analysis is able to ingest multiple variables. The user or an automated process is able to specify the parameters desired within the specified dataset(s) in order to find a similar event. This process is applicable across multiple industries which have dataset(s) that are or have the ability to be converted into a gridded dataset. This process allows for various datasets to be converted into a unique binary dataset in which the algorithm may utilize in order to identify the similar events.

The disclosed embodiments include a process and system to identify similar events using unique characteristics, gridded location and time data, and proprietary algorithm analysis. The disclosed algorithm and its implementations analyze a user depicted event or an automatically input event for unique characteristics. The disclosed algorithm also evaluates the event against a uniquely generated binary dataset (which contains all the unique characteristics per grid value for the entire gridded dataset) with selected or identical parameters.

The purpose of converting the data into a binary form is to extract only the relevant values and characteristics from a specific data point within the original dataset, assign necessary metadata per data point, and significantly reduce the size of the historical database to an efficient algorithm query and response level. The disclosed algorithm is functional with raw gridded data sets which are typically gigabytes or terabytes in size, with millions of individual data points (and oftentimes multiple types of data assigned to a single gridded data point), and require the use of a computer to read the raw data files and the associated metadata. Execution time of the similar event algorithm on a binary historical dataset (with the original raw data in upwards of terabytes of data) is typically less than sixty (60) seconds. The extraction of the relevant values from the raw gridded data by hand on an individual data point level and analyzing the data for similar events is not feasible without the use of a computer (which also requires the ability to read and interpret the raw datasets). The algorithm also outputs a rank order list of events similar to that which is depicted, or characteristic inputted and correlates the events with a separate dataset.

A user may execute the disclosed process and associated implementations to uniquely specify the desired characteristics of a selected or defined event by depicting the location, intensity, and evolution of a specific event, selecting or isolating the event to a specific area, selecting whether the search should be a firm location search or allow for some degree of freedom, selecting a time period in which to search for similar events within the historical gridded binary dataset, applying data specific characteristics to the search criteria for the purpose of improved identification of similar events, and identifying information contained within the separate dataset that is relevant and connected with the identified similar event(s).

The disclosed process and methods may include three primary steps. The first step may establish a historical binary gridded dataset from which the similar event algorithm may identify similar events. The second step may accept user or automated input of the desired or defined similar event. Once the gridded binary dataset and the similar event are selected, additional possible refinements of the similar event data are identified. The third step includes the similar event algorithm being applied to search for unique characteristics of the user or automated depicted event (desired event) and compares those characteristics to the data available in the historical binary gridded dataset.

The unique characteristics of each data point are evaluated by a computer generated process on an individual basis, comparing the desired events data point characteristics with each of the corresponding events location and associated characteristics within the historical binary gridded datasets.

An output, or result, from the disclosed similar event algorithm includes a rank order list of similar events as compared to the user depicted or defined event. Results also include a rank value to aid in determining the similarity of the event and output from the separate dataset for each event. The similar event algorithm rank orders the similarity by evaluating the number of potential data points included in the evaluation, establishing a maximum possible value, and dividing the maximum possibly value by the similarity event value to calculate a percentage of similarity.

Results also may include information from the historical gridded binary dataset for purposes of displaying or reviewing the results as ranked or presented. If a separate dataset is available and offered in the analysis or application of the similar event algorithm, then applicable information in the separate dataset is applied to the similar events identified by the similar event algorithm. The purpose of the separate dataset is to provide an additional means in which to include related, yet secondary values for refinement in identifying similar events. A user may have a primary dataset in which to complete the similar event analysis; however, an additional dataset which contains the same gridded data schema may be used as an additional filter in the analysis.

Thus, the disclosed embodiments identify characteristics to quickly mine and develop results from the gridded binary dataset that are used to provide visual or graphical representations to a user. The disclosed embodiments take into account the evolution (if more than one instance is selected) and characteristics of a specific event and relate it to a dataset of these characteristics. The disclosed embodiments provide user-defined machine intelligent normalization to vast amounts of data for identification of events of interest.

A method for identifying similar events from machine-readable data is disclosed. The method includes receiving base event input data. The method also includes converting the base event input data into binary data having characteristics. The method also includes executing a similar event algorithm using the converted binary data and historical binary gridded data. The similar event algorithm takes into account the characteristics. The method also includes generating a similar event dataset based on results of the similar event algorithm.

A method for identifying similar events within a database of machine-readable data also is disclosed. The method includes establishing historical binary gridded data having a binary format in the database. Each data point within the data includes metadata associated with the data point. The method also includes receiving base event input data having characteristics. The method also includes converting the base event input data into the binary format. The method also includes executing a similar event algorithm using the historical binary gridded data and the base event input data using the characteristics to identify associated metadata in the binary format. The method also includes generating a similar event dataset having at least one of the characteristics.

A method for identifying similar events in machine-readable data also is disclosed. The method includes receiving a dataset of base event input data. The method also includes converting the dataset of base event input data into a dataset of binary input data. The method also includes comparing the dataset of binary input data to a dataset of historical binary gridded data. The method also includes generating a dataset of similar event data.

Further, a system for identifying similar events within a database of machine-readable data is disclosed. The system includes a historical binary gridded dataset to store historical data. The system also includes a binary user specified event dataset. The system also includes a computer to execute a similar event algorithm to compare the binary user specified event dataset to the historical binary gridded dataset to generate a similar event dataset. The similar event dataset includes at least one similar event identified from the historical binary gridded dataset.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed by the claims and their equivalents.

FIG. 1A illustrates a system 1 for identifying similar events according to the disclosed embodiments.

FIG. 1B illustrates a flow diagram for identifying similar events according to the disclosed embodiments.

FIG. 2 illustrates the computer process which converts raw gridded data into a historical binary gridded dataset which will then be accessed and analyzed by the similar event algorithm according to the disclosed embodiments.

FIG. 3 illustrates a flow diagram for the similar event algorithm process according to the disclosed embodiments.

FIG. 4 illustrates a flowchart for an example process of selecting parameters and/or characteristics as an application of the similar event algorithm as it relates to the field of atmospheric science according to the disclosed embodiments.

FIG. 5 depicts a block diagram of the different data as used in the similar event algorithm according to the disclosed embodiments.

### DETAILED DESCRIPTION OF THE PREFERRED EMBODIMENTS

Aspects of the invention are disclosed in the accompanying description. Alternate embodiments of the present invention and their equivalents are devised without parting from the spirit or scope of the present invention. It should be noted that like elements disclosed below are indicated by like reference numbers in the drawings.

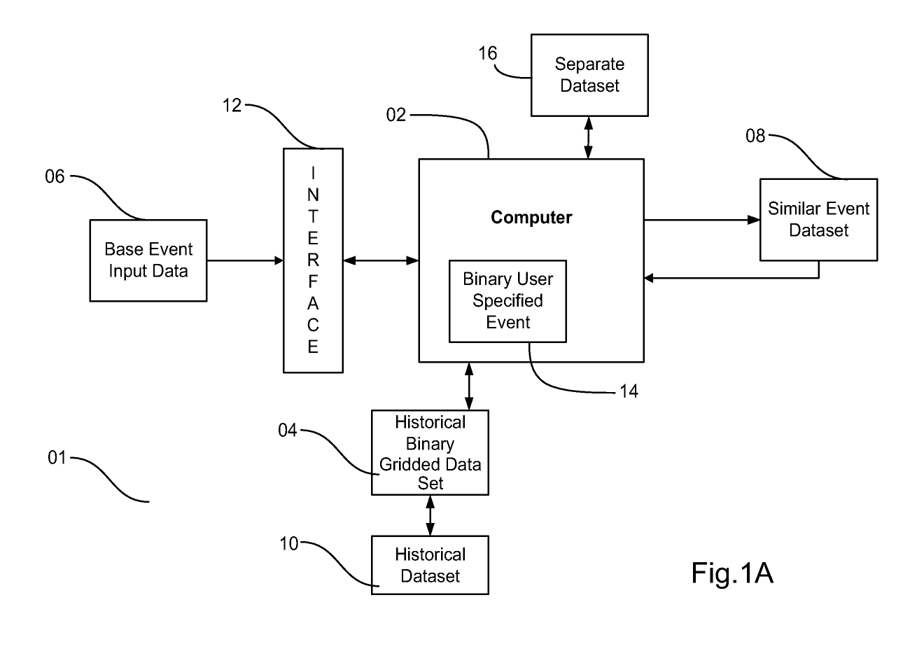

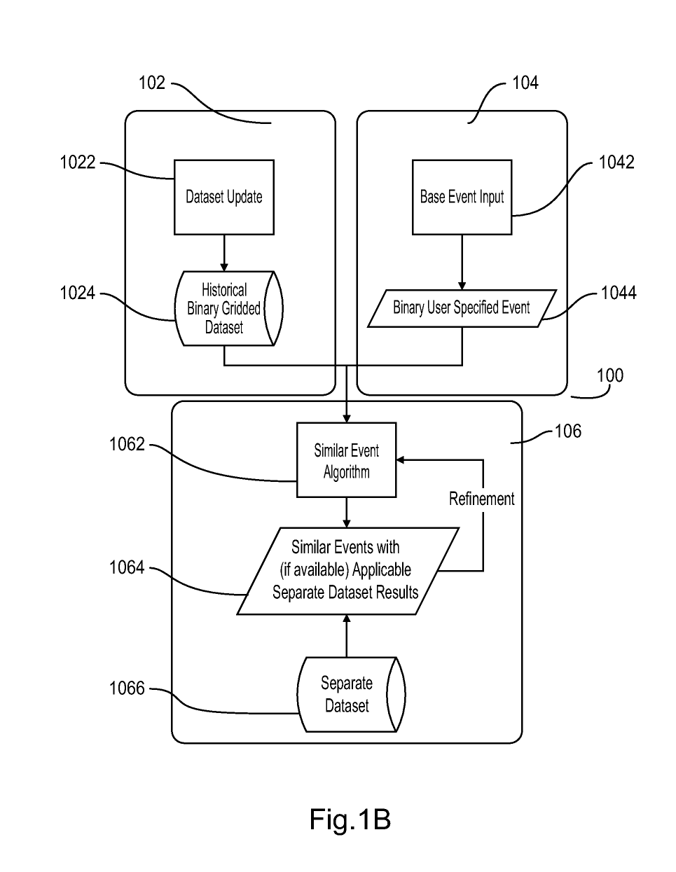

FIG. 1A depicts a system 1 for identifying similar events according to the disclosed embodiments. System 1 also may refer to a device, machine, platform, network, virtual machine, and the like that is able to host a computing platform and access memory locations that store data. System 1 is shown to illustrate that data residing in these memory locations is accessed to generate similar events dataset 8.

System 1 includes computer 2. Computer 2 includes a processor to perform actions and the associated software executing the processes disclosed below. Computer 2 may refer to any device or machine that can execute instructions. Preferably, computer 2 includes instructions to execute the similar event algorithm and processes disclosed below. The instructions may be stored in a memory within computer 2, and execute when system 1 is enabled. When executing the disclosed similar event algorithm, computer 2 receives and manipulates data that is in a machine-readable form. Although not shown, computer 2 also may include a display to graphically show data.

System 1 includes historical binary gridded dataset 4. As disclosed in greater below, dataset 4 includes a large amount of historical data pertaining to a topic. Preferably, dataset 4 includes data points and associated metadata that is gigabytes and terabytes in size. Dataset 4 also may be referred to as a database or data files. Dataset 4 also may refer to a server or other memory storage to host the data.

Dataset 4 includes data in a binary format that is converted from historical dataset 10. For example, historical dataset 10 may relate to daily weather patterns for a region over the last 50 years. Preferably, the data may be imposed on a grid for spatial display of the dataset as a whole. The grid may be supported by computer 2. A data point in historical dataset 10 is converted into a binary data point within dataset 4. Historical dataset 10 may be collected over a period of time by system 1 or accessed at a large data storage location.

Historical dataset 10 and dataset 4 include data points relating to an event stored within the data. A data point also may have associated metadata, which may be referred to as data that describes the data point. An example may be weather temperature or temperature conditions for a specified geographic location on a certain date. Once converted, metadata may form a recognizable pattern in the binary format. These recognizable patterns may be searched and documented. Thus, the events of historical dataset 10 may be represented in a binary format within dataset 4 along with any descriptive or identifying data for that event.

System 1 also includes an interface 12 that receives input from a user to query dataset 4 and identify similar events based on the data therein. Interface 12 may be a graphical user interface or an application that allows the user to enter information pertaining to a base event. This information may be known as base event input data 6. Base event input data 6 may be an event defined by the user or an event that already occurred. Interface 12 may reside or be supported by computer 2.

Computer 2 may execute a conversion process to convert base event input data 6 into base event binary dataset 14, which is used in the disclosed algorithm and processes below to identify similar events within database 4. Computer 2 may store base event binary dataset 14 in a memory location.

Separate dataset 16 also may be used by computer 2 in executing the algorithm to identify similar events. The function of separate dataset 6 is disclosed in greater detail below. Separate dataset 6 includes related secondary values for refining the identification process executed by computer 2. In other words, separate dataset 6 may be used as a gridded dataset filter on dataset 4.

As an example, dataset 4 may be a primary dataset used for identifying similar events. Separate dataset 16 may be a secondary dataset. The primary dataset may be a set of numbers across a domain while the secondary dataset is a set of colors. A query could complete the analysis and identify similar events just on the numbers, but also could use better, more refined information using the set of colors. Using this example, the query could be interested in numbers values that are blue, as shown in the secondary dataset.

After applying the disclosed processes, computer 2 generates similar events dataset 8. Similar events dataset 8 may be a ranked list of events identified in dataset 4 (historical binary gridded data) that are similar to the base event input data. Similar events dataset 8 may be stored in a separate location than the other datasets and database, and preferably does not overwrite these datasets. Alternatively, computer 2 may output similar events dataset 8 as file.

Using the above example, base event input data 6 may be a string of numbers representing an event. Computer 2 converts base event input 6 into a binary format useable for the identification process as base event binary dataset 14. Computer 2 then executes the disclosed algorithm to identify similar strings of numbers from historical binary gridded dataset 4. Not every string may be an exact match, and, in fact, there may be no exact matches. Thus, computer 2 identifies strings having similar characteristics to the input string. Further, the query may want strings having blue numbers, and this is represented by separate dataset 16. Similar events dataset 8 is generated and lists those strings of numbers similar to the input data, possibly having those strings with most matched numbers at the top, with blue numbers taking priority. This example is illustrative only, and the disclosed processes and algorithm are not limited to the example. Moreover, additional separate datasets 16 may be used by computer 2.

System 1 is not limited to the components shown in FIG. 1A, and may include other devices, computers, datasets, and the like. The remaining figures may refer back to the components of system 1, but these are not limited to the structures disclosed therein.

FIG. 1B depicts a high level flowchart 100 of the process for identifying similar events according to the disclosed embodiments. FIG. 1 shows each of the key aspects to the similar event process and methods that are germane to the disclosed algorithm and its associated output/results. Prior to executing the algorithm, in order to identify the similar events compared to the specified event, the disclosed embodiments establish historical gridded binary dataset 4, which is accessible by the disclosed similar event algorithm to query, to input information and for the user to specify unique criteria of interest.

Steps 102, 104 and 106 show the broad steps of the process disclosed above. These broad steps may be broken into sub-steps as shown in FIG. 1. Step 102 executes a computer process by generating or creating historical gridded binary dataset 4. The disclosed algorithm may run queries to identify similar events to the specified criteria or event on the historical binary gridded dataset 4. As disclosed below, historical binary gridded database 4 may be referred to as gridded historical event database 4.

Step 1022 executes by updating historical binary gridded dataset 4 through a manual or automated process. Like any large amount of data, updates are needed to add entries to the dataset or modify existing data to better reflect the historical events represented therein. This update may occur periodically by, for example, system 1 or as directed by a user using computer 2. Alternatively, whenever a query is received by system 1 to identify similar events in dataset 4, then system 1 may look for applicable updates to the data. For example, historical binary gridded dataset 4 may update automatically every month. New or modified data are added to dataset 4. Alternatively, an update occurs when instructed by computer 2, possibly in response to a user query or command.

Step 1024 executes by generating the historical binary gridded dataset 4 from the updated dataset. This process is disclosed in greater detail below.

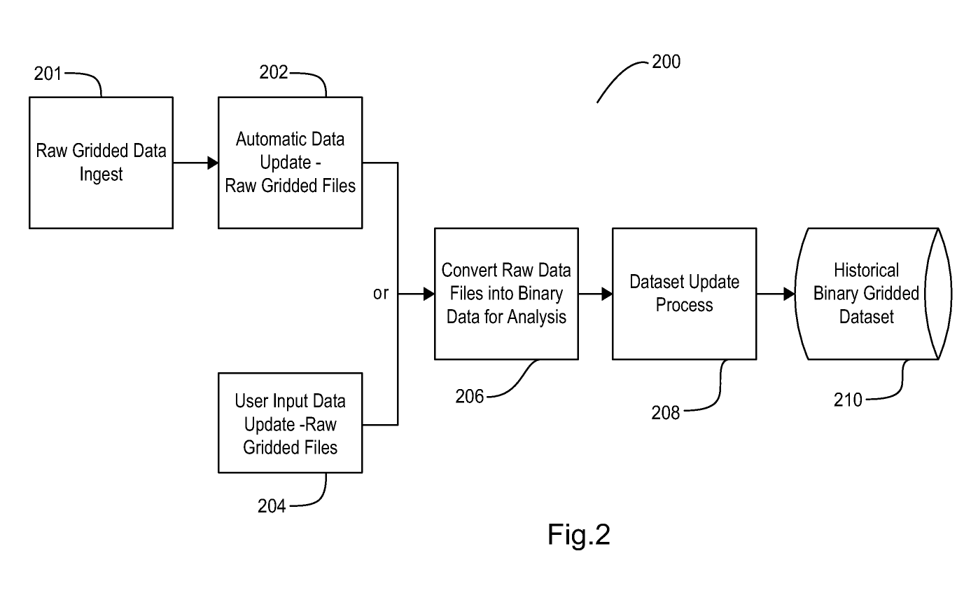

The disclosed embodiments describe a computer processes which convert a raw gridded dataset into a form which the disclosed similar event algorithm may complete its analysis to identify similar events. Raw gridded data for this purpose is defined as a machine only-readable set of data which contain metadata about the data set and has an assigned value(s) for individual, regularly separated data points throughout the domain of the entire data. The processes which convert the data from the raw gridded data require a computer process because the size of data covering decades is large, such as gigabytes and terabytes. The raw gridded data conversion process is completed through various computer processes and may be shown in more detail by FIG. 2.

FIG. 2 depicts a flowchart 200 for converting raw gridded data, shown as historical dataset 10 in FIG. 1A, into the historical binary gridded dataset 4 for use by the similar event algorithm. The computer process of ingesting, or compiling, the raw gridded data is illustrated in step 201. Step 202 executes by receiving an automatic dataset update having raw gridded files. These files may be received by the disclosed embodiments to update historical dataset 10. Alternatively, step 204 may execute by receiving a user input dataset by which the user would input the raw gridded files manually into the appropriate file structure. The raw gridded files may be data pertaining to a specific type of events of which the user desires to search for similar events. The gridded files preferably are large data files that can only be analyzed as a practical matter by a computer or processor, such as computer 2 disclosed above.

Step 206 is a computer process which executes by converting the raw data files into a binary form which the disclosed similar event algorithm may complete its analysis to identify similar events. The computer generated conversion process involves evaluating the individual grid cells within the raw gridded data for: unique values, characteristics, location and the like, and assigning a binary value to represent these items. In other words, data points, metadata, and other associated information may have a unique binary number or value within dataset 4. The binary values may be pre-assigned to provide uniform values for specified types of data. Step 206 also may generate a binary file that represents all of the necessary characteristics of the gridded data file for each of the individual gridded cells within the dataset. The purpose of converting the raw gridded data into a binary dataset is described above, and serves to facilitate efficient identification by the disclosed algorithm.

Step 208 is a computer process which executes by performing a dataset update process, whether through appending the current dataset in the computer process determined location or generating a new gridded binary file. Historical binary gridded dataset 4 is composed of binary code that is unique to each application of the disclosed similar event algorithm. Each component or characteristic of the data has a unique location and a string of binary code associated with the applicable component or characteristic. For example, the temperature for a specified geographic location on a certain date has a binary value stored in dataset 4. Step 210 represents the historical binary gridded database which is ready for the execution of the disclosed similar event algorithm, and corresponds to a final version of dataset 4 disclosed above.

Referring back to FIG. 1, step 104 includes a number of options that aid in allowing a user to depict a base event uniquely in order for the similar event algorithm to hone in on the characteristics of a specified event. The event may be a single instance of time or consecutive instances of time which align with the dataset time periods. In other words, the dataset may include historical binary gridded data files for the past three (3) years in hourly, daily, or hourly time steps (for example). Events outside that time period may not be available to show as similar events. The disclosed embodiments may encompass any range of time periods and is only limited by the data itself.

Depending upon the application in which the process is employed, users have the ability to automatically ingest an input gridded dataset or the user may have the option to interact with a graphical user interface (GUI) and depict the event (draw via a mouse and keyboard mechanism via a GUI). Both the automatically ingested raw gridded data and the GUI input data from the user is converted into binary data which the similar event algorithm uses as the base event when analyzing the historical event data. The base event is defined as the event which the user selects as the event which they would like to view similar events. The GUI provides the user in manual mode with a variety of options in which to select base events that are applicable to the dataset (e.g., location, magnitude, orientation within the gridded dataset, and the like). The result is base event input data 6 received or defined by interface 12.

Because the user is depicting events along a grid, the GUI offers the user the ability to save scenarios which were previously depicted by the user to a file. The user also has the ability to save or copy user depicted subsets of the gridded data for the purposes of pasting those depictions for future searches or to paste previously saved areas and adjusting as needed to fit a new search criteria. For example, this feature may be a “stamp” function where the user can save a portion of a depicted area which is defined as a stamp and paste [stamp] on the current depiction or save the stamp for future search iterations.

Step 1042 executes by providing a base event input (either user specified or automatically ingested). Again, the base event input corresponds to base event input data 6 of FIG. 1A. Step 1044 executes by converting the input from step 1042 into a base event binary dataset 14 for use within the disclosed similar event algorithm and computer 2. The process of completing step 1044 is similar to the conversion process disclosed by FIG. 2. Base event binary dataset 14 will store the input data in a binary format for use by the disclosed algorithm. This process is disclosed in greater detail below.

While depicting or specifying the base event, the user also has multiple options that may be used when the similar event algorithm is searching through the historical binary gridded dataset 4. Depending upon the application invoked, the user has the option to specify the range of data within the historical binary gridded dataset 4 in which to compare the base event input data 6, such as year(s), month(s), day(s), hour(s), geography and the like. The user may also specify an area or subset of data within the binary gridded dataset and whether the search is limited to a firm comparison search or specify thresholds as needed utilizing a separate dataset.

Examples of each of the criteria options are disclosed below. If the gridded binary dataset is populated with dated events ranging from 2008 through 2011 in 30 minute increments, and the user is only interested in similar events which occurred during the years 2007 through 2009 during the hours 1000 through-1200 Greenwich Mean Time (GMT), then an option exists for the user to search the dataset 4 to find similar events which only occurred during the user specified time period. The user may specify different time increments or time periods, or time of day, as needed. The user may retrieve data for ranges of time based on temporal parameters.

Other criteria options include searching by specific area within the gridded dataset in which the user may specify the exact area within the gridded dataset for the purposes of excluding data outside the non-specified area. For example, if the application was employed in a geographic setting, the user may specify a state or region of a country to search for similar events, rather than searching the dataset of the entire world.

Another unique feature of the similar event analysis is the option to select a specific location (firm) search or to allow for a search which is location “variant.” If the specific location search is selected, then the disclosed similar event algorithm may evaluate the characteristics of the exact gridded data location of the base event (for those cells which do not have a null value only) to the associated exact gridded data location of the data in the historical binary gridded dataset 4. If the search for a similar event includes a tolerance factor that is specified by the user, then the base event is adjusted according to the tolerance specified by the user and conducted as often as specified with a new set of similar event calculations completed for each of the iterations.

For example, a user selected tolerance of “3” means the granular grid cells which do not have a null value will move to the right, left, up, and down (on the grid) in single step increments up to “3” granular grid cells and the similar event algorithm will search for similar events at each step. The option removes the exact gridded location search limitation and offers the user to be presented with similar events that have characteristics similar to the ones selected. The location of the event, however, may be offset by a maximum location threshold as specified by the user.

Users also have the ability to specify additional dataset filters, such as maximum, minimum, average values, increase or decrease in values, and the like, using a separate dataset that may be utilized in conjunction with the identified similar events. The disclosed similar event algorithm may identify the similar events using the primary historical binary gridded dataset and then apply any additional filters as specified by the user resulting in using the separate dataset. The algorithm may identify the area of interest by identifying the applicable area within the subset of the overall boundary search area where the event is located. A subset of the non-null areas (the areas of high interest to the user as opposed to the entire subset, however, this may vary depending upon the application of the process) within the base event will be evaluated using the additional filters.

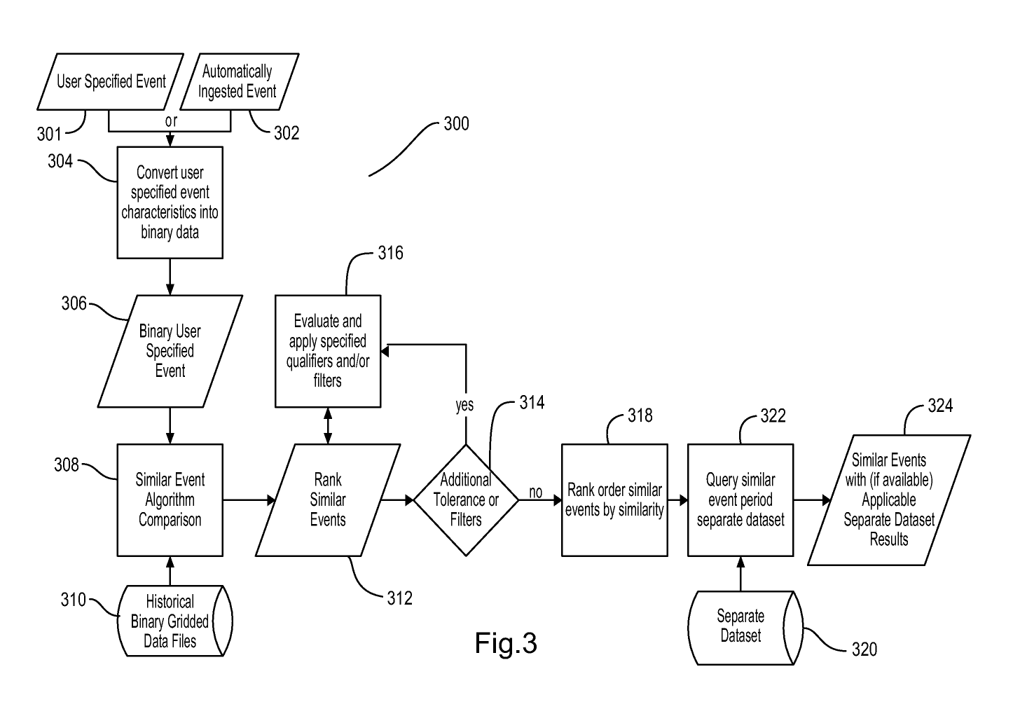

Referring back to FIG. 1, step 106 includes steps to execute the disclosed similar event algorithm. Step 1062 executes the similar event algorithm. Step 1064 executes by associating the identified similar events with, if applicable, applicable separate dataset results. Step 1066 executes accessing the separate dataset. These steps are disclosed in greater detail by FIG. 3.

FIG. 3 depicts a flowchart 300 for the similar event algorithm process according to the disclosed embodiments. FIG. 3 is one of a variety of processes to execute the similar event algorithm. Step 301 and step 302 executes by performing or receiving a user specified event or automatically ingested event. This event may correspond to base event input data 6. The steps shown in FIG. 3 may be executed by computer 2.

The user has multiple options available in which to identify a specific time period or event in which to compare (e.g., specific year(s), month(s), and/or hour(s) of the day), the geographic area, and whether the search is limited to a firm location comparison search or varied tolerance, as described previously. The base day selection is critical for the similar weather event algorithm to identify and apply those key characteristics to the computations desired by the user. An option is also given to the user to select whether to invoke a firm location search or whether there is some tolerance the user may give to the depicted area as disclosed above.

Step 304 executes by converting the user specified event into a unique binary data file, or data, which is machine or computer readable data and represents all the characteristics of the user specified event. This data file is shown as base event binary data 14 in FIG. 1A. The conversion of the user specified event (i.e., location, intensity, and other characteristics per time iteration) into a binary code format not only aids in reducing the computer processing time, but it also reduces the amount of memory space needed for storing queries when the application is located on a computer or other processing machine. Step 306 executes by determining a binary user specified event for use in identifying similar events. Thus, the user specified event may be represented by a binary code.

Step 308 executes by comparing the user specified event, or base event binary dataset 14, to the historical binary gridded dataset 4, once the user specified event is converted to the unique binary file. This step may be known as executing the similar event algorithm. Step 308 is accomplished by accessing the historical binary gridded dataset, made available, or accessed as a result of step 310. The historical binary gridded datasets, as disclosed above with dataset 4, are a collection of unique binary gridded dataset that allow for the algorithm to efficiently and quickly identify similar events to the user specified event.

The algorithm takes the base event binary data that represents the base input data and searches through the historical event dataset. The binary format of the data points and associated metadata allows for efficient and timely matching of the data to the data points for identification. In other words, the strings of binary data are compared, and matched according to the algorithm. Those data points that match according to a given criteria may be used as similar events. The algorithm also may set limits on deviations within the binary numbers for close matches, as it is possible that no exact matches exist within the historical data. For example, a percentage of binary numbers may match to be considered.

Step 312 executes ranking similar events. The output of the disclosed similar event algorithm is a ranked order list of similar events by order of similarity. How ‘similar’ an event is to the base event is calculated and ranked by the disclosed similar event algorithm. The output from the algorithm generates a file structure which is referenced in a way that GUIs would be able to display or output the data from the historical binary gridded dataset. Step 314 executes by determining if there are any additional filters, specified tolerances, or the like that need to be applied to the original list of similar events. A user may select a number of different additional filters, as disclosed above.

If step 314 is yes, then step 316 executes by evaluating and applying the specified qualifiers or filters. The additional filters are disclosed above and serve to further refine the results of the similar event algorithm. The results from the further refinement are then re-ranked in order of similarity. For example, the filter may specify to move left or right, up or down within the dataset 4 from identified similar event data points. If step 314 is no, then flowchart 300 moves to step 318. Step 318 executes by analyzing the similar characteristics of each of the dataset files compared with the base event depicted or chosen by the user. Step 318 also ranks the similarity of each event. This ranking may represent the final rank order. A rank value may be determined based on the amount that the data values match, and associated with each ranked event.

Step 320 executes by accessing a separate dataset, such as separate dataset 16 shown in FIG. 1A, containing relevant data to the similar events identified by the similar event algorithm disclosed previously. Step 322 executes by querying the separate dataset for information regarding the identified similar events. An additional, separate dataset that is relevant to the similar events in question may be accessed or incorporated. Once the similar event algorithm has identified and ranked the similar events, the disclosed similar event algorithm may search for any additional datasets chosen by the user. The disclosed similar event algorithm may identify the similar events and search the additional dataset to retrieve any relevant information usable in the analysis.

Step 324 executes by outputting similar events, shown as similar events dataset 8 in FIG. 1A, with applicable separate dataset results. This output may be a flat file that lists the similar events in order of similarity to the base event, lists a representative number indicating how similar the event is to the base event, lists the separate dataset information for each of the similar events, and presents any information from the historical binary gridded dataset which aids in the data being extracted directly from the historical binary gridded dataset for the purposes of displaying the data visually or graphically.

After the similar event algorithm has executed, there are many options for the user to display the information using computer 2. For example, a GUI may be provided that lists the similar events in order of similarity, graphically displays the similar events, allows the user to export the similar event list, and allows the user to import any of the similar events as a base similar event so that the user may then conduct a search on similar events using the imported data.

An example of the disclosed embodiments being applied to the atmospheric science field may be a similar weather event identification process for weather events. The similar weather event identification process identifies similar weather events using the unique characteristics and the disclosed similar event algorithm analysis. A user may select various characteristics that are used to identify similar weather patterns.

For example, the user may select a specific geographic area. The user also may depict the orientation, intensity and growth or decay of a specific weather event. The user also may select whether the search should be a firm location search or if there should be a tolerance geographic area (i.e., characteristic location variance) around the user depicted area. The user also may select the time period in which to search for similar weather events. The user also may apply additional characteristics to the weather to better identify similar weather events.

By allowing the user to specify the desired weather criteria, area of interest, and time period, the disclosed similar event algorithm uses the selections to search through the historical binary gridded “weather” datasets to identify weather events that are similar. The historical binary gridded “weather” dataset is an embodiment of the historical binary gridded datasets disclosed above. The disclosed embodiments present the user with a list of “similar weather” events identified in the dataset that match as close as possible to the user specified weather event. The user may select any of the “similar weather” events from the list and overlay the data on top of a graphic representation, or a display.

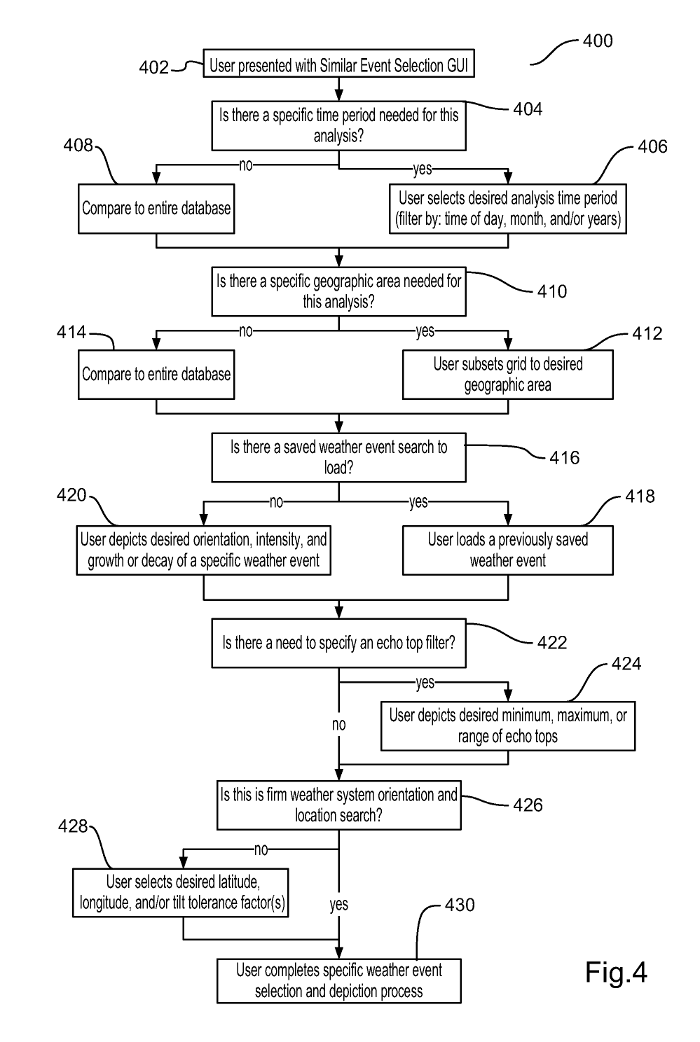

FIG. 4 depicts a flowchart 400 for an example process of selecting parameters and characteristics to identify similar weather events using the similar event algorithm according to the disclosed embodiments. Step 402 executes by presenting the user with a similar weather event selection GUI, or any other input device, such as a touch screen device. Further, the user may input instructions from a virtual or connected keyboard.

Step 404 executes by determining whether a specific time period is needed for the analysis. If yes, then step 406 executes by having the user select the desired analysis time period using filters, such as time of day, month, year, season and the like. If step 404 is no, then step 408 executes by comparing this parameter or characteristic to the entire historical binary gridded dataset.

Step 410 executes by determining whether a specific geographic area is needed for the analysis. If yes, then step 412 executes by filtering down to the user specified geographic area or region. If step 410 is no, then step 414 executes by comparing this parameter or characteristic to the entire historical binary gridded dataset.

Step 416 executes by determining whether a saved weather event search is available to load. If yes, then step 418 executes by having the user load a previously saved weather event. This feature allows the user to load a previously documented event, such as a snowstorm in January of a particular year, for comparison and analysis. If step 416 is no, then step 420 executes by having the user depict the desired orientation, intensity, and growth or decay of a specific weather event.

For this application, there is a separate dataset which contains related data to the weather events. Step 422 executes by determining whether the user requires the use of the separate dataset. If yes, then step 424 executes by extracting the information necessary from the identified similar weather events in the analysis.

Step 426 executes by determining whether the requested analysis is a firm weather system orientation and location search, previously disclosed above. If yes, then step 426 executes by having the user complete the specific weather event selection and depiction process. If step 424 is no, then step 428 executes by having the user select desired latitude, longitude, tilt tolerance and other like factors, which completes the specific weather event selection and depiction process. This feature allows the algorithm to deviate and take into account a greater number of potential similar events.

As with the process disclosed by FIG. 1B, the selected characteristics are used by the algorithm to search and identify relevant data within the historical binary gridded “weather” dataset. The historical binary gridded “weather” dataset includes gridded binary dataset segregated by regular time increments, such as minutes, seconds, hours and the like. The disclosed similar event algorithm queries the historical binary gridded “weather” dataset with the characteristics selected or established above in FIG. 4.

The similar event algorithm evaluates the characteristics, evolution and intensities of the weather depicted or imported by the user, and compare those characteristics to the historical binary gridded “weather” dataset. Thus, using the processes disclosed above, the algorithm filters the dataset to those days applicable to the base event. For example, if the user selects only a certain time period, then the disclosed similar event algorithm queries the historical binary gridded “weather” dataset for only the user specified time period. Another example may filter by geographic area. This query results in a candidate list of similar weather events.

The disclosed similar event algorithm then evaluates the base event by identifying the characteristics of the base event for comparison to the candidate list of similar weather events. Calculations are computed to compare the base event to the candidate list of events.

A unique feature of the disclosed similar event analysis is also given to the user to select whether to invoke a firm location search or whether there is some tolerance the user may give to the depicted area, as disclosed above.

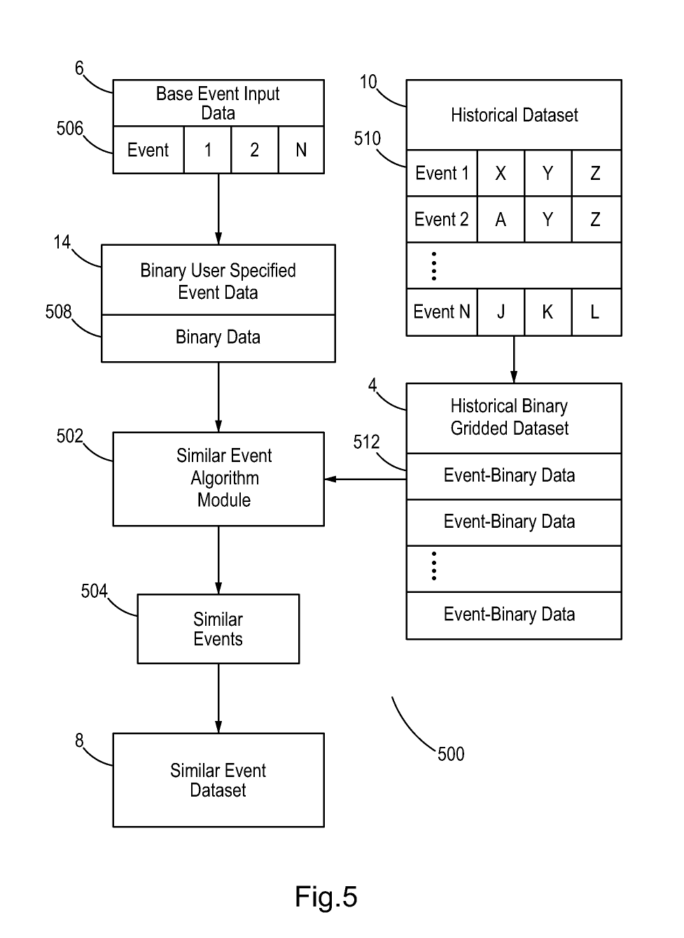

FIG. 5 depicts a block diagram 500 of the different data as used in the similar event algorithm according to the disclosed embodiments. Diagram 500 provides a visual representation of the event data used in the processes disclosed above. The blocks shown in FIG. 5 represent machine-readable data that is used by a processor, such as within computer 2, to identify similar events.

Historical dataset 10 is disclosed above. It includes event data 510. Event data 510 includes different events having characteristics, or metadata, that further define the events listed in dataset 10. For example, event 1 may include characteristics X, Y and Z. Event 1 may be a time event while characteristic X is the temperature, Y is the humidity, Z is the wind speed, and so on. Additional characteristics may be included for each event. Event 2 also includes characteristics, with some matching the characteristics of event 1, while others differ. For example, event 2 may have A for the temperature instead of X. Event N may represent another value in historical dataset 10 having no characteristics in common with events 1 and 2.

As disclosed above, historical binary gridded dataset 4 corresponds to historical dataset 10 and stores the binary values 512 of the events 510 in dataset 10. Preferably, each event data entry 510 has a binary event data entry 512. Thus, event 1 and its characteristics are represented by a binary value in dataset 4. All the events listed in dataset 10 have binary values. Both datasets 4 and 10 may be updated with new events.

Base event input data 6 also is disclosed above, and includes an event of interest 506, Event 506 includes characteristics as well. These characteristics may include some or all of the characteristics represented in historical dataset 10. Base event input data 6 is converted into binary user specified event data 14, as disclosed above. Entry binary data 508 is the binary value associated with event 506.

Similar event algorithm module 502 then executes the similar event algorithm to identify binary values that best match entry binary data 508. The algorithm searches historical binary gridded dataset 4 to find data blocks that match the binary value entered. The algorithm may specify the size of the blocks searched, the percentage of matched binary values to qualify as a similar event, and the like. The algorithm may be changed as desired, and is not static in its implementation. Module 502 executes the steps of comparing and identifying those entries within dataset 4 that should be considered similar events.

Module 502 then outputs similar events 504, which may be a list of events corresponding to entries within dataset 10 for use or display. The disclosed embodiments may then rank the similar events, as disclosed above, to generate similar event dataset 8. Preferably, the entries in dataset 8 resemble the entries in dataset 10, but also may be binary values for use with additional processing operations, or manipulation.

The disclosed embodiments may be supported and executed on a platform that has access to a network. The platform may support software and executable programs to provide the functionality disclosed above. For instance, the software may be deployed. Any software embodying the similar event algorithm and its processes may be deployed by manually loading directly to the client, server and proxy computers via loading a storage medium such a CD, DVD, flash memory, chip, downloadable program and the like. The software also may be automatically or semi-automatically deployed into a computer system by sending the process software to a central server or a group of central servers. The software is downloaded into the client computers that execute the programs and instructions associated with the software.

Alternatively, the software may be sent directly to the client system via email. The software may be detached to a directory or loaded into a directory by a button on the email that executes a program that detaches the software into a directory. Another alternative is to send the software directly to a directory on the client computer hard drive. When there are proxy servers, the disclosed embodiments will select the proxy server code, determine on which computers to place the proxy servers' code, transmit the proxy server code, and install the proxy server code on the proxy computer. The software may be transmitted to the proxy server and then stored on the proxy server.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

It will be apparent to those skilled in the art that various modifications and variations can be made in the disclosed embodiments of the similar event algorithm and its associated processes without departing from the spirit or scope of the invention. Thus, it is intended that the present invention covers the modifications and variations of the embodiments disclosed above provided that the modifications and variations come within the scope of any claims and their equivalents.

1. A method for identifying similar events from machine-readable data, the method comprising:
receiving base event input data;
converting the base event input data into binary data having characteristics;
executing a similar event algorithm using the converted binary data and historical binary gridded data, wherein the similar event algorithm takes into account the characteristics; and
generating a similar event dataset based on results of the similar event algorithm.

2. The method of claim 1, wherein the generating step includes ranking a plurality of similar events within the similar events dataset.

3. The method of claim 1, further comprising generating the historical binary gridded data from a historical dataset.

4. The method of claim 1, further comprising converting the historical dataset into the historical binary gridded data.

5. The method of claim 1, further comprising representing the characteristics as metadata associated with at least one data point.

6. The method of claim 1, wherein the executing step includes comparing the converted binary data to the historical binary gridded data.

7. The method of claim 1, further comprising accessing a dataset of the historical binary gridded data.

8. A method for identifying similar events within a database of machine readable data, the method comprising:
establishing historical binary gridded data having a binary format in the database, wherein each data point within the data includes metadata associated with the data point;
receiving base event input data having characteristics;
converting the base event input data into the binary format;
executing a similar event algorithm using the historical binary gridded data and the base event input data using the characteristics to identify associated metadata in the binary format; and
generating a similar event dataset having at least one of the characteristics.

9. The method of claim 8, further comprising displaying a graphical representation of the similar event dataset.

10. The method of claim 8, further comprising applying a qualifier or a filter to the similar event dataset.

11. The method of claim 8, further comprising identifying a separate dataset to apply to the similar event dataset.

12. A method for identifying similar events in machine-readable data, the method comprising:
receiving a dataset of base event input data;
converting the dataset of base event input data into a dataset of binary input data;
comparing the dataset of binary input data to a dataset of historical binary gridded data; and
generating a dataset of similar event data.

13. The method of claim 12, further comprising applying a filter to the dataset of similar event data.

14. The method of claim 12, further comprising retrieving the dataset of base event input data for a user-specified event.

15. A system for identifying similar events within a database of data, the system comprising:
a historical binary gridded dataset to store historical data;
a binary user specified event dataset; and
a computer to execute a similar event algorithm to compare the binary user specified event dataset to the historical binary gridded dataset to generate a similar event dataset, wherein the similar event dataset includes at least one similar event identified from the historical binary gridded dataset.

16. The system of claim 15, wherein the binary user specified event dataset is generated from base event input data.

17. The system of claim 15, further comprising a separate dataset accessible by the computer for use by the similar event algorithm.

18. The system of claim 15, further comprising an interface to define the binary user specified event dataset.

19. The system of claim 15, further comprising an interface to receive base event input data, wherein the computer is configured to convert the base event into the binary user specified event dataset.
